(19) United States
(12) Patent Application Publication
(10) Pub. No.: US 2008/0063421 A1
(43) Pub. Date: Mar. 13, 2008

(54) IMAGE FORMING APPARATUS

(75) Inventor: Masayuki Tamaki, Toride-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/848,465

(22) Filed: Aug. 31, 2007

(30) Foreign Application Priority Data
Sep. 8, 2006 (JP) 2006-243937

(51) Int. Cl. G03G 15/00

(52) U.S. Cl. 399/74

(57) ABSTRACT

An image forming apparatus includes a first image forming station for forming, on the basis of an input signal indicative of an image, a toner image on a recording material with such a toner of toners having the same hue and different lightness as has a predetermined color and a low lightness; a second image forming station for forming, on the basis of an input signal indicative of an image, a toner image on the recording material with such a toner of the toners having the same hue and different lightness as has the predetermined color and a high lightness; changing means for changing a toner amount per unit area in each of the first image forming station and the second image forming station in accordance with a density level indicated by the image input signal for the predetermined color so that in a low density range, the toner amount per unit area is larger in the second image forming station than in the first image forming station; a first residual toner container for accommodating toner removed by first cleaning means for removing toner remaining on a surface of the first image bearing member; and a second residual toner container for accommodating toner removed by second cleaning means for removing toner remaining on a surface of the second image bearing member.

### FIELD OF THE INVENTION AND RELATED ART

The present invention relates to an image forming apparatus which forms an image on recording medium and has multiple image forming portions arranged in tandem.

There have been made various attempts to make simpler in structure and smaller an image forming apparatus which employs multiple image forming portions. As one of the results of these attempts, an image forming apparatus, the multiple image forming portions of which are individually provided with a container for storing the waste toner discharged from the image forming portion.

More specifically, there is the image forming apparatus design disclosed in Japanese Laid-open Patent Application 2004-21134. In the case of this design, the process cartridge which contains black toner, that is, the toner which is highest in usage frequency, is substantially greater in the capacity of the waste toner container than the process cartridges for toners other than black toner. It seems to be reasonable to think that the reason why black toner is greater in the amount of consumption than color toners is that the frequency with which an ordinary multi-color image forming apparatus is used in the black-and-white mode is greater than the frequency with which the image forming apparatus is used in the monochromatic modes (other than black-and-white mode) or multicolor mode, and therefore, the number of the black-and-white copies formed by the ordinary multi-color image forming apparatus is greater than the number of monochromatic color copies or multicolor copies formed by the same image forming apparatus.

In recent years, digital technologies have remarkably advanced. With the advance of these digital technologies, demand has been increasing for an electrophotographic image forming apparatus which is substantially higher in image quality than a conventional image forming apparatus, not only in the POD market and office supply market, but also, in the ordinary consumer product market. Demand has been also increasing for an image forming apparatus capable of forming an image which matches in quality and characteristics an image formed by the screen process printing method, and forming an image matching a silver-salt photograph in gradation, an image forming apparatus which is substantially wider in the range of the color it can reproduce than a conventional image forming apparatus, and an image forming apparatus capable of forming an image which is significantly less grainy than that formed by a conventional image forming apparatus.

Thus, in order to substantially improve in image quality a conventional image forming apparatus which primarily uses four inks different in color, it has been proposed to increase the number of color inks which the conventional electrophotographic color image forming apparatus uses.

More specifically, it has been proposed to add light color toners, such as light cyan toner and light magenta toner, to the typical four toners different in color, that is, cyan, magenta, yellow, and black toners (dark color toner). This proposal has been recorded in Japanese Laid-open Patent Application H05-35038.

It has been also proposed, in Patent Document 2, for example, to use transparent toner in addition to the abovementioned four dark color toners different in color.

The purpose of adding the light color toners which are the same in hue, but, less in density, as recorded in Japanese Laid-open Patent Application H05-35038 is to achieve a higher level of image quality by reducing graininess. FIG. 5 shows the covering power of light cyan toner (which hereafter will be referred to as LC toner), and the covering power of dark cyan toner (which hereafter will be referred to as DC toner). The broken line represents the covering power of the LC toner, and the solid line represents the DC toner). When the amount of LC toner on a given area of a sheet of paper was 0.5 mg/cm², the optical density (O.D.) of the area was 0.7. When the amount of dark cyan toner (DC toner) on a given area of a sheet of paper was 0.5 mg/cm², the optical density (O.D.) of the area was 1.4.

The amount (mg/cm²) of toner on a given area of a sheet of paper plotted in FIG. 5 is the amount of toner measured before fixation, whereas the optical density plotted in FIG. 5 is the optical density measured after fixation.

Latent images are formed and developed according to the lookup table for LC toner, and the lookup table for DC toner, in FIG. 6. Then, the obtained LC toner image and DC toner image are layered to yield a cyan toner image whose density is proportional to the values of the picture signals as shown in FIG. 7.

Incidentally, this method for forming a monochromatic image is different from the conventional one, which uses only dark cyan toner (DC toner), in that when the value of an inputted picture signal corresponds to the low density range, LC toner, that is, the cyan toner which is the same in hue as the DC toner, but, is lighter in density than the DC toner, is primarily used, whereas when the value of an inputted picture signal corresponds to the middle density range, light and dark cyan toners are used in combination. Further, when the value of an inputted picture signal corresponds to the high density range, DC toner, that is, the cyan toner which is the same in hue as the LC toner, but, is higher in density, is primary used. This arrangement makes it possible to yield an image which is significantly less grainy across the low density areas, and the high density area of which is significantly smaller in the amount of dark toner usage, than an image yielded with the use of only DC toner. In particular, it is effective to yield an image which is significantly higher in image quality, in that the image is less grainy across its low density area, than an image formed by a conventional image forming apparatus, and also, it is effective to widen the range of color spectrum reproducible by a multicolor image forming apparatus.

The usage of the above described method for forming a monochromatic cyan image is not limited to the formation of a monochromatic cyan image.

A photographic image, such as a picture of natural scenery, is desired to be wider in color reproduction range, across the halftone areas or areas brighter than the halftone areas, and also, to be less grainy, than a textual image or the like. Thus, some image forming apparatuses for forming a photographic image were enabled to use two toners, which are the same in hue, but, different in density when forming a monochromatic toner image of a certain color. More specifically, they are designed to use only light color toner, or be higher in the ratio of the light toner usage relative to the dark toner usage, when forming the brighter areas (highlight areas) of the image, that is, the areas which are smaller in gradation value, as shown in FIG. 6. Therefore, in the case of an image forming apparatus enabled to use two toners which are the same in hue, but, different in density, to form a monochromatic image of a certain color, the amount of light toner consumed for image formation was generally greater than the amount of dark toner consumed for image formation.

To further describe the above-mentioned phenomenon with reference to an image forming apparatus which uses dark cyan toner and light cyan toner, that is, the two cyan toners which are the same in hue, but, different in density, the image forming apparatus is likely to consume more light cyan toner than dark cyan toner, even when forming a monochromatic image of cyan color. Therefore, the waste toner container of the image forming apparatus, which is for light cyan waste toner, has to be replaced more frequently than the waste toner containers for the other toners. Thus, this type of image forming apparatus is problematic in that an image forming operation carried out by this type of image forming apparatus has to be interrupted more frequently than that carried out by an ordinary image forming apparatus.

As one of the solutions to the above described problem, it is possible to increase in capacity the containers for the toner higher in the frequency of usage, as proposed in Japanese Laid-open Patent Application 2004-21134. However, simply adopting the proposal made in Japanese Laid-open Patent Application 2004-21134 cannot fully solve the above-mentioned problem. That is, according to this proposal, when cyan toners are higher in the frequency of usage, the waste toner container for the dark cyan toner, and the waste toner container for the light cyan toner, are simply increased in capacity. Therefore, the problem attributable to the fact that the amount of light color toner consumption is greater than the amount of dark color toner consumption, that is, the problem that the waste toner container for light color waste toner is shorter in service life (length of time it takes for container to be filled up with waste toner) than the waste toner container for the dark color waste toner.

That is, the simple adoption of the image forming apparatus design disclosed in Japanese Laid-open Patent Application 2004-21134 is insufficient to control the difference in the frequency of replacement between the dark color waste toner container and light color waste toner container, which is attributable to the fact that the ratio of usage between the dark color toner and light color toner is affected by the changes in desired level of density.

### SUMMARY OF THE INVENTION

Thus, the primary object of the present invention is to provide an image forming apparatus which has two or more image forming portions, as does the image forming apparatus described above, and yet, is smaller than the above described image forming apparatus, and whose waste toner containers for toners which are the same in hue, but, different in density, are different in capacity, being therefore virtually the same in the frequency of replacement.

According to an aspect of the present invention, there is provided an image forming apparatus comprising a first image forming station for forming, on the basis of an input signal indicative of an image, a toner image on a recording material with such a toner of toners having the same hue and different lightness as has a predetermined color and a low lightness; a second image forming station for forming, on the basis of an input signal indicative of an image, a toner image on the recording material with such a toner of the toners having the same hue and different lightness as has the predetermined color and a high lightness; changing means for changing a toner amount per unit area in each of said first image forming station and said second image forming station in accordance with a density level indicated by the image input signal for the predetermined color so that in a low density range, the toner amount per unit area is larger in the second image forming station than in the first image forming station; a first residual toner container for accommodating toner removed by first cleaning means for removing toner remaining on a surface of said first image bearing member; and a second residual toner container for accommodating toner removed by second cleaning means for removing toner remaining on a surface of said second image bearing member.

According to another aspect of the present invention, there is provided an image forming apparatus comprising a first image forming station including a first image bearing member, first developing means for developing an electrostatic latent image formed, in accordance with an input signal indicative of an image, on a surface of said first image bearing member, with such a toner of toners having the same hue and different lightness as has a predetermined color and a low lightness, and a first toner supply container for supplying toner to said first developing means, said first image forming station being effective to form the toner image on a recording material; a second image forming station including a second image bearing member, second developing means for developing an electrostatic latent image formed, in accordance with an input signal indicative of an image, on a surface of said second image bearing member, with such a toner of the toners having the same hue and different lightness as has the predetermined color and a low lightness, and a second toner supply container for supplying toner to said second developing means, said second image forming station being effective to form the toner image on the recording material; and changing means for changing a toner amount per unit area in each of said first image forming station and said second image forming station in accordance with a density level indicated by the image input signal for the predetermined color so that in a low density range, the toner amount per unit area is larger in the second image forming station than in the first image forming station.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a schematic drawing of the image forming apparatus in the first preferred embodiment of the present invention, showing the general structure of the apparatus.

FIG. 2 is an enlarged view of the image forming portion of the image forming apparatus in the first or second preferred embodiments.

FIG. 3 is an enlarged view of the image forming portion of the image forming apparatus in the third, fourth, fifth, or sixth preferred embodiment of the present invention.

FIG. 4 is a schematic drawing of the image forming apparatus in the second preferred embodiment of the present invention, showing the general structure of the apparatus.

FIG. 5 is a graph showing the covering powers of the light and dark toners.

FIG. 6 is a graph showing the relationship between the input picture signals and output picture signals, regarding the light and dark toners.

FIG. 7 is a graph showing the relationship between the value of input picture signals and output picture signals when an image is formed of a combination of the light and dark cyan toners.

### DETAILED DESCRIPTION OF THE PREFERRED EMBODIMENTS

Hereinafter, the preferred embodiments of the present invention will be described with reference to the appended drawings. If any structural component, apparatus, structural portion, etc., in one of the drawings is the same as the one in another drawing, the two will be designated by the same referential symbol.

Obviously, image forming apparatuses to which the structural design for an image forming apparatus, which characterizes the present invention, is applicable, is not limited to those which will be described next.

The image density (optical density after image fixation) which will be mentioned in the following description of the preferred embodiments of the present invention is the image density measured with the use of a spectro-densitometer 504 (product of X-Rite). The recording medium on which a toner image was formed was ordinary paper (80 g/cm² in basis weight) for a copying machine (product of Canon). Images were formed on this paper so that the amount by which toner was deposited per unit area of recording medium was 0.5 mg/cm². The images formed under the above described conditions were randomly measured five times in image density, and the obtained average value was used as the value of image density.

As for the method for measuring the amount (per unit area) of the toner on an image bearing member or a sheet of recording medium, the toner on an image bearing member or a sheet of recording medium was suctioned into a container having a preset shape, before fixation. Then, the weight of the container is subtracted from the weight of the combination of the container and the toner therein. Then, the difference was divided by the area of the recording sheet across which the toner was present. The thus obtained value was used as the amount of toner on the recording medium per unit area.

### Embodiment 1

### (1) General Structure of Image Forming Apparatus

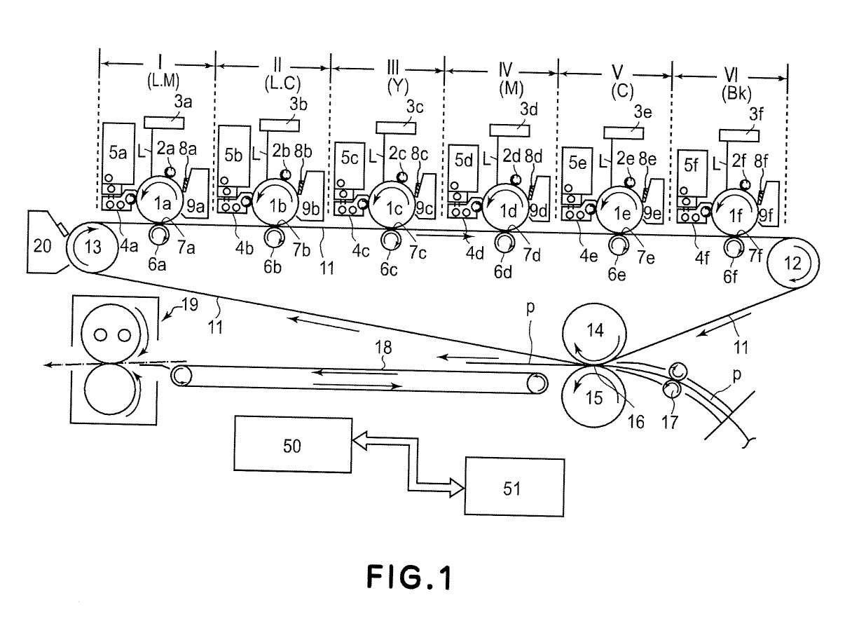

FIG. 1 is a schematic drawing of the image forming apparatus in this embodiment, and shows the general structure of the apparatus. This image forming apparatus is an electrophotographic full-color copying machine, which employs an intermediary transfer belt, and six photosensitive drums juxtaposed in parallel (which is referred to as inline or tandem arrangement). It can output a full-color image on a sheet of recording medium, such as various paper, OHP sheet, fabric, or the like.

Designated by a referential number 50 is a control circuit portion of the image forming apparatus, which is the controlling means for controlling the overall operation of the image forming apparatus. The electrical pictographic information is inputted into this control circuit portion 50 from a photoelectric image reading apparatus 51 (reader portion, whose structure is not shown), which separates the optical image of an original into a preset number of monochromatic optical images of primary colors.

Designated by referential Roman numerals I, II, III, IV, V, and VI are first to sixth image forming portions, respectively, which are juxtaposed in parallel in a straight line in the left-to-right direction of the drawing. Each of these image forming portions is an electrophotographic image formation system which uses a beam of laser light as an exposing means.

More specifically, designated by alphanumeric referential symbols 1(a-f) are electrophotographic photosensitive members (which hereafter may be referred to as drums), as first image bearing members, which are in the form of a drum. Designated by alphanumeric referential symbols 2(a-f) are charge rollers, as charging means, which uniformly charge the peripheral surfaces of the drums 1(a-f) to preset polarity and potential level while the drums 1(a-f) are rotated. Designated by alphanumeric referential symbols 3(a-f) are laser scanners, as latent image forming means, which form an electrostatic latent image on the peripheral surface of the corresponding drum. More specifically, each laser scanner scans (exposes) the uniformly charged peripheral surface of the corresponding drum with a beam of laser light L which it outputs while modulating the beam of laser light L with picture information signals. As a result, a latent image which reflects the pattern of the exposure is formed on the peripheral surface of the drum. Designated by alphanumeric referential symbols 4(a-f) are developing apparatuses, which develop the electrostatic latent images on the peripheral surfaces of the drums, into toner images (images formed of toner), one for one. Designated by alphanumeric referential symbols 5(a-f) are toner bottles (toner cartridges, toner supply containers, etc.), which are toner supply sources for the developing apparatuses 4(a-f), respectively. Designated by alphanumeric referential symbols 6(a-f) are primary transfer rollers (primary transferring means), as second image bearing members, which are kept pressed against the drums 1(a-f), with the presence of an intermediary transfer belt 11 (intermediary transferring member) between the transfer rollers 6(a-f) and photosensitive drums 1(a-f), respectively. The intermediary transfer belt 11 (which hereafter will be referred to as belt) is circularly driven in the clockwise direction indicated by an arrow mark. The interfaces between the drums 1(a-f) and belt 11 are the primary transfer nips 7(a-f), respectively. To the transfer rollers 6(a-f), transfer bias, the polarity of which is opposite to the polarity of the toner charge, is applied from a transfer bias application power source (unshown). As the transfer bias is applied to the transfer rollers 6(a-f), the toner images on the rotating drums 1(a-f) are sequentially transferred (primary transfer) onto the surface of the circularly moving belt 11. Designated by alphanumeric referential symbols 8(a-f) are drum cleaning apparatuses, as cleaning means, which clean the peripheral surfaces of the drums 1(a-f), respectively; the drum cleaning apparatuses 8(a-f) remove the toner particle remaining on the peripheral surfaces of the drums 6(a-f) after the primary transfer, so that the peripheral surfaces of the drums 1 can be repeatedly used for image formation. In this embodiment, each of the cleaning apparatuses 8(a-f) is an elastic blade (cleaning blade) which extends in the direction parallel to the generatrix of the drum, and is in contact with the peripheral surface of the drum, being tilted so that its cleaning edge is on the upstream side of its base portion in terms of the rotational direction of the drum. Thus, as the drums 1(a-f) are rotated, the peripheral surfaces of the drums are wiped by the blade 8(a-f). As a result, the toners remaining on the peripheral surfaces of the drums are scraped down into waste toner containers 9(a-f), respectively, in which the toners are stored.

Hereafter, if any structural component, apparatus, structural portion, etc., which is to be designated by an alphanumeric referential symbol, is designated by a numeric referential symbols 1-9, that is, without alphabetic suffixes, it means that it is common among the first to sixth image forming portions I, II, III, IV, V, and VI.

The first to sixth image forming portions I-VI form on the peripheral surfaces of the drums 1, toner images, the color of which are light magenta (M), light cyan (LC), yellow (Y), magenta (M), cyan (C), and black (Bk), respectively. Thus, the developing apparatuses 4 and toner bottles 5 of the first to sixth image forming portions I-VI contain light magenta toner, light cyan toner, yellow toner, magenta toner, cyan toner, and black toner, as developers, respectively.

The belt 11 is an endless flexible belt formed of resin or rubber. The belt 11 is under the first to sixth image forming portions I-VI, and is stretched around, being thereby suspended by, three parallel rollers, that is, a driver roller 12, which is at the right-hand end in the drawing, a turn roller 13, which is at the left-hand end in the drawing, and a belt-backing roller 14, which is located lower than the driver roller 12 and opposes a secondary transfer roller with the presence of the belt 11 between the two rollers. The positional relationship among the belt 11, driver roller 12, turn roller 13, and drums 6 is such that the portion of the belt 11, which is moving between the driver roller 12 and turn roller 13, are placed in contact with the downwardly facing portion of each of the drums 6 in the image forming portions 1, forming thereby the primary transfer nips 7. The belt 11 is circularly driven by the driver roller 12 in the clockwise direction indicated by the arrow mark, at roughly the same velocity as the peripheral velocity of the drums 1.

To describe the transfer process, first, in the primary transfer nip 7a of the first image forming portion I, the magenta toner image, that is, the toner image of the first color, on the drum 1a, is transferred (primary transfer) onto the belt 11, which is being circularly driven. Next, in the primary transfer nip 7b of the second image forming portion II, the light cyan toner image, that is, the toner image of the second color, is transferred (primary transfer) onto the belt 11 so that it is layered on the magenta toner image, that is, the toner image of the first color, on the belt 11. Similarly, in the primary transfer nips 7c-7f of the third to sixth image forming portions III-VI, the yellow toner image, magenta toner image, cyan toner image, and black toner image, that is, the third to sixth colors, respectively, are sequentially transferred (primary transfer) onto the belt 11 so that they are layered on the preceding toner images on the belt 11.

That is, six toner images different in color or tone, that is, light magenta, light cyan, yellow, magenta, cyan, and black toner images, are sequentially transferred in layers (multilayer transfer) onto the surface of the belt 11. As a result, an unfixed full-color toner image is synthetically effected on the surface of the belt 11.

Then, the synthetically effected unfixed full-color toner image on the belt 11 is conveyed to a secondary transfer nip 16 by the subsequent circular movement of the belt 11. The secondary transfer nip 16 is the interface between the secondary transfer roller 15 (secondary transferring means), and the portion of the belt 11, which is between the belt backing roller 14 and secondary transfer roller 15.

Meanwhile, a sheet of recording medium P (transfer medium), as the third image bearing member, is fed with preset control timing, into the main assembly of the image forming apparatus from a sheet feeder cassette of an unshown sheet feeding mechanism, while being separated from the rest of the sheets of recording mediums in the sheet feeder cassette. Then, the sheet of recording medium P is conveyed to a pair of registration rollers 17, which are remaining stationary, and is caught by the nip between the two registration rollers 17, being thereby corrected in attitude if it is askew. Then, the pair of registration rollers 17 are rotated with preset control timing, conveying thereby the recording medium P to the secondary transfer nip 16. That is, the rotation of the registration rollers 17 is started with such timing that the arrival of the leading edge of the unfixed full-color toner image on the belt 11 at the second transfer nip 16 coincides with the arrival of the print-start line of the recording medium P at the secondary transfer nip 16. Then, the recording medium P is conveyed through the secondary transfer nip 16. While the recording medium P is conveyed through the secondary transfer nip 16, remaining pinched between the belt 11 and secondary transfer roller 15, transfer bias, which is a preset amount of voltage, is applied to the secondary transfer roller 15 from a transfer bias application power source (unshown). The transfer bias is opposite in polarity to the electric charge of the toner. As a result, the unfixed six monochromatic color toner images, which are effecting the unfixed full-color toner image on the belt 11, are transferred together (secondary transfer) onto the recording medium P.

After being conveyed out of the secondary transfer nip 16, the recording medium P is separated from the belt 11 by the curvature of the belt 11, and then, is conveyed to a fixing apparatus 19 by a conveyer belt 18. The fixing apparatus 19 in this embodiment is a fixing apparatus which uses heat and pressure to fix an image. It is made up of primarily a heat roller and a pressure roller. The recording medium P is conveyed through the fixation nip, that is, the compression nip between the abovementioned two rollers, while remaining pinched by the two rollers. As the recording medium P is conveyed through the fixation nip, the recording medium P and unfixed full-color toner image thereon are subjected to heat and pressure. As a result, the toners of which the toner images on the recording medium P are made, melt, mix, and permanently adhere (fix) to the recording medium P. Then, the recording medium P is discharged as a full-color print from the image forming apparatus.

After the separation of the recording medium P from the belt 11, the surface of the belt 11 is cleaned by a belt cleaner 20 (toner remaining on the surface of the belt 11 after the secondary transfer is removed by the belt cleaner 20) to be readied for the subsequent image formation process.

When the image forming apparatus is in the black-and-white mode, the sixth image forming portion VI, that is, the image forming portion for forming a black toner image, is fully activated, whereas the first to fifth image forming portions I-V are rotationally driven without being used for image formation. Thus, it is only the black toner image, that is, the toner image formed on the drum if (drum of the sixth image forming portion VI) that is transferred (primary transfer) onto the belt 11. Then, the black toner image is transferred (secondary transfer) onto the recording medium P in the secondary transfer nip 16. After being conveyed out of the secondary transfer nip 16, the recording medium P separates from the belt 11 due to the curvature of the belt 11, and is introduced into the fixing apparatus 19, in which the black toner image is fixed to the recording medium P. Then, the recording medium P is discharged as a black-and-white print from the image forming apparatus.

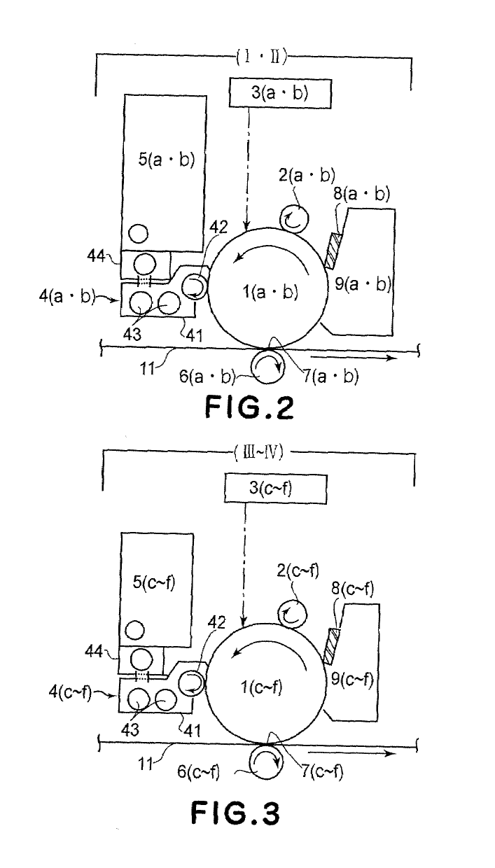

FIG. 2 is an enlarged schematic drawing of the first or second image forming portions I and II, respectively, and FIG. 3 is an enlarged schematic drawing of the third, fourth, fifth, or sixth image forming portions III, IV, V, and VI. Referring to FIGS. 2 and 3, designated by a referential number 41 is a developing means container of the developing apparatus 4, with which each of the first to sixth image forming portions I-VI is provided. Designated by referential numbers 42 and 43 are a development sleeve and a developer stirring-conveying screw, respectively, which are in the developing means container 41. Designated by a referential number 44 is a toner hopper, which is located on the top side of the developing means container 41. A toner bottle 5, which is the toner supply source, is removably mounted on top of the toner hopper 44. The development sleeve 42 is positioned so that its peripheral surface is in contact with the peripheral surface of the drum 1, or a small gap is provided between the two surfaces. The development sleeve 42 is rotationally driven so that its peripheral surface and the peripheral surface of the drum 1 move in the same direction where the distance between the two surfaces is zero or smallest. The developer in the developing means container 41 is stirred by the screws 43, and is picked up by the peripheral surface of the rotating development sleeve 42. Then, the developer on the peripheral surface of the development sleeve 42 is conveyed by the rotation of the development sleeve 42 to the interface or gap between the peripheral surface of the development sleeve 42 and the peripheral surface of the drum 1. To the development sleeve 42, a preset development bias is being applied from a developer bias application power source (unshown). Therefore, the electrostatic latent image on the peripheral surface of the drum 1 is developed into an image formed of toner (which hereafter will be referred to as toner image). The developing device 4 is structured so that in order to compensate for the consumption of the toner in the developing means container 41, the toner in the toner bottle 5 is supplied, as necessary, to the developing means container 41 through the toner hopper 44. The developer in the developing means container 41 is made up of a single or two components.

Each of the first-six image forming portions I-VI in the image forming apparatus in this embodiment is in the form of a process cartridge, which is removably mountable in the main assembly of the image forming apparatus. Each process cartridge is made up of the drum 1, charge roller 2, developing apparatus 4, cleaning apparatus 8, waste toner container 9, and a cartridge in which the preceding components are integrally disposed. Each process cartridge may be designed as an ALL-IN-ONE process cartridge, that is, a process cartridge which includes a toner bottle 5 in addition to the above listed components. Incidentally, the process cartridge in this embodiment is desired to have a minimum of the drum 1, cleaning apparatus 8, and waste toner container 9.

### (Portion for Forming Toner Image of Light Color, and Portion for Forming Toner Image of Dark Color)

The light magenta toner and light cyan toner used by the first and second image forming portions I and II are such toners that if the amount per unit area of an unfixed toner image on recording medium is 0.5 g/cm², the optical density of the toner image will be 0.7 after the fixation. Hereafter, these toners will be collectively referred to as light toners. Thus, the first and second image forming portions I and II will be collectively referred to as light toner image forming portions.

The yellow, magenta, cyan, and black toners used by the third to sixth image forming portions III, IV, V, and VI are such toners that if the amount per unit area of an unfixed toner image on recording medium is 0.5 g/cm², the optical density of the toner image will be 1.4 after the fixation. Hereafter, these toners will be collectively referred to as dark toners. Thus, the third to sixth image forming portions III-VI will be collectively referred to as dark toner image forming portions.

In this specification of the present invention, “light color toner” and “dark color toner” means two color toners which are the equal in the spectral characteristics of the coloring agent (pigment or dye) which they contain, but, different in the amount of the coloring agent they contain. That is, a light toner and a dark toner, which are the same in color, are the same in hue, but, different in density. It may be said that a light color toner is a color toner which has been adjusted in the amount of coloring agent so that if it is deposited on recording medium by 0.5 mg/cm², the optical density of the toner will be no more than 1.0, whereas the dark color toner is a color toner which has been adjusted in the amount of coloring agent so that if it is deposited on recording medium by 0.5 mg/cm², the optical density of the toner will be no less than 1.0.

In this embodiment, the image forming apparatus is provided with a lookup table (LUT) as a means for adjusting the ratio between the amount by which a dark toner is used and the amount by which light toner is used, according to the level of an input picture signal, as shown in FIG. 6. In other words, the amount by which dark color toner is used and the amount by which light color toner is used are controlled based on this lookup table.

FIG. 7 is a graph showing the density curve of an image formed while controlling the amount by which dark toner was used and the amount by which light toner was used, as described above. The horizontal axis represents the tone, as the horizontal axis of FIG. 6 does, and the vertical axis represents the image density. It is evident from this graph that using only light color toner for the highly light areas of the image, and using dark toner and light toner in combination for the halftone areas of the image, made it possible to form an image which is satisfactory from the standpoint of tone reproduction.

A color image forming apparatus which employs no less than five toners different in color or density, as described above, can reproduce a wide range of the colors, in particular, the colors which are in the middle to high range in terms of brightness, and are very important when outputting a pictographic image of natural scenery or the like. Thus, it can form an image which matches in quality a silver-salt photograph.

Thus, of two color toners which are the same in hue and different in density, the amount by which the light color toner, that is, the toner which bears the role of reproducing halftone areas of an image, is consumed when forming a pictographic image is greater than the amount by which the dark toner is consumed when forming the pictographic image.

However, a color image forming apparatus designed as described above is problematic in that it sometimes forms an image having a pseudo contour (unsmooth transition in density) at the border between the area formed of light toner alone and the area formed of a combination of dark and light toners. As one of the solutions to this problem, it is possible to widen the range (in terms of tone) in which light color toner is used. This solution, however, exacerbates the problem that the amount of light color toner consumption is greater than that of dark toner consumption.

For the reasons stated above, of the two color toners which are the same in hue, but, different in density, the amount of lighter color toner consumption is greater than the amount of the darker color toner consumption. Thus, if the waste toner containers 9a-9f of the first to sixth image forming portions 1a-1f, respectively, are the same in capacity, the waste toner containers 9a and 9b, that is, the waste toner containers for the light color toners, are filled up sooner than the waste toner containers 9d and 9e, that is, the waste toner containers for the dark color toner. That is, the waste toner containers 9a and 9b, that is, the waste toner containers for the light color toner, are shorter in service life than the waste toner containers 9d and 9e, that is, the waste toner containers for the dark color toner. This is problematic in that an image forming operation has to be interrupted with a substantial frequency just to replace the waste toner containers 9a and 9b, or the waste toner containers for the light color toner.

Incidentally, in the case that a waste toner container is an integral part of the process cartridge as is the waste toner containers of the image forming apparatus in this embodiment, the “service life” and “replacement” of a waste toner container are synonymous to the “service life” and “replacement” of a process cartridge.

In this embodiment, therefore, the waste toner containers 9a and 9b of the image forming portions I and II, that is, the waste toner containers for light magenta waste toner and light cyan waste toner, are rendered greater in capacity than the waste toner containers 9d and 9e of the image forming portions IV and VI, that is, the waste toner containers for dark magenta waste toner and dark cyan waste toner, extending thereby the light color waste toner containers 9a and 9b in the length of their service lives, respectively.

Further, since the amount of light color toner consumption is greater than the amount of the dark color toner consumption, not only are the waste toner containers 9a and 9b rendered greater in capacity than the waste toner containers 9d and 9e, but also, the toner bottles 5a and 5b, that is, the light color toner supply sources, are rendered greater in capacity than the toner bottles 5c, 5d, 5e, and 5f, that is, the toner bottles for dark color toners. Incidentally, in this embodiment, the toner hopper 44 of the developing apparatus 4 of each of the first and second image forming portions I and II, that is, the toner hoppers for the light color toner, are increased in capacity to accommodate the toner bottles 5a and 5b which are substantially larger than the rest of the toner bottles 5.

In the case of this specification of the present invention, “capacity of toner bottle” is synonymous to the capacity of the toner storage capacity of a toner bottle. “Capacity of a waste toner container” is synonymous to the waste toner (primary transfer residual toner) storage capacity of a waste toner container.

The inventors of the present invention studied about the capacity of which the light color toner bottles 5a and 5b are required when forming an image which matches a silver-salt photograph in quality.

In the abovementioned studies, several hundred images of ordinary sceneries (people, buildings, skies, seas, mountains, clouds, night sceneries, vehicles, etc.), which have roughly 2-10 million picture cells, matching therefore a silver-salt photograph, were printed based on the LUT (tone curve) shown in FIG. 6. The amount of light color toner consumption was roughly 2.2 times the amount of dark color toner consumption.

Based on the above finding about the amount of toner consumption, the toner bottles 5a and 5b, that is, the toner bottles for light color toner, were designed to be roughly 2.2 times, in toner capacity, the toner bottles 5c, 5d, 5e, and 5f, that is, the toner bottles for darker color toner. After the implementation of this design, the toner bottles for the light color toners and the toner bottles for the dark color toners were the same in the frequency with which they had to be replaced.

The toner bottles 5a and 5b, that is, the toner bottles for light color toner, in this embodiment, had a toner capacity large enough to print 1,000 copies of A4 size at a print ratio of 50%, which is the average ratio of light color toner usage in photographic printing; the toner bottles 5a and 5b ran out of toner soon after 1000th copy was printed.

More concretely, the largest amount per unit area by which light color toner is adhered to the peripheral surface of the drum to develop a latent image on the peripheral of the drum is 0.6 mg/cm². Thus, the total amount of light color toner consumed for development, to print 1,000 A4 size copies of photographic quality, which is 50% (average ratio) in the printing ratio of light color toner, is roughly 187 g. Therefore, the toner capacity for the toner bottles 5a and 5b, that is, the toner bottles for light color toner, was set to roughly 190 cm³.

On the other hand, in consideration of the abovementioned relationship between the amount of light color toner consumption and the amount of dark color toner consumption, the toner capacity for the toner bottles 5c, 5d, 5e, and 5f was set to roughly 90 cm³.

Further, the inventors of the present invention studied about the amount of capacity of which the waste toner containers 9a and 9b, that is, the waste toner containers for light color waste toner, was required to yield a given number of copies.

In consideration of the relationship between the amount of light color toner consumption and the amount of the dark color toner consumption, the size of the waste toner containers 9a and 9b, that is, the waste toner containers for light color waste toner, was made to be roughly 2.2 times that of the waste toner containers 9c, 9d, 9e, and 9f, that is, the waste toner containers for dark color toner.

Next, the actual size of the waste toner container 9 will be described. The formula for calculating the amount of waste toner capacity necessary for each of the waste toner containers 9 is as follows:

η1 (%)=c/a×100

η1 represents the primary transfer efficiency. The letter a stands for the amount of the toner which a toner image on the peripheral surface of the drum 1 has prior to the primary transfer in each of the image forming portions (process cartridges), and the letter c stands for the amount of toner which the toner image has after the transfer (primary transfer) of the toner image from the drum 1 onto the belt 11. Further, the letter b stands for the amount of toner on the drum 1 after the transfer (primary transfer) of the toner image from the drum 1 onto the belt 11.

Thus, a=b+c

Thus, η1 (%)=c/a×100

In this embodiment, the average primary transfer efficiency among the image forming apparatuses I-VI was 90%.

10% of the entire amount of toner consumption of the image forming apparatus, that is, 18.7 g of toner (waste toner) is stored in the combination of the waste toner containers 9a and 9b, that is, the waste toner containers for light color toner. Thus, in consideration of the phenomenon (fog formation) that toner adheres to the areas of recording medium, which correspond to the white (blank) portions of an original, the size of the internal space of each of the light color waste toner containers 9a and 9b was set to 25 cm³.

As for the size for the waste toner containers 9c, 9d, 9e, and 9f, that is, the waste toner containers for dark color toner, the waste toner containers 9c, 9d, and 9e were designed so that the amount of space which the waste toner could occupy in each of them was 15 cm³.

The numerical values quoted above are the actual values used in this embodiment. However, the toner bottles 5 and waste toner containers 5 may be given a certain amount of reserve capacity.

As for the selections of color toners, it is optional. That is, the color toner combination other than the one in this embodiment may be used. For example, three or more color toners which are the same in hue, but, different in density, may be employed for each or some of the primary colors, or color toners of special color, for example, orange color toner, gold color toner, etc., may be used to afford more latitude in chromatic expression.

### Embodiment 2

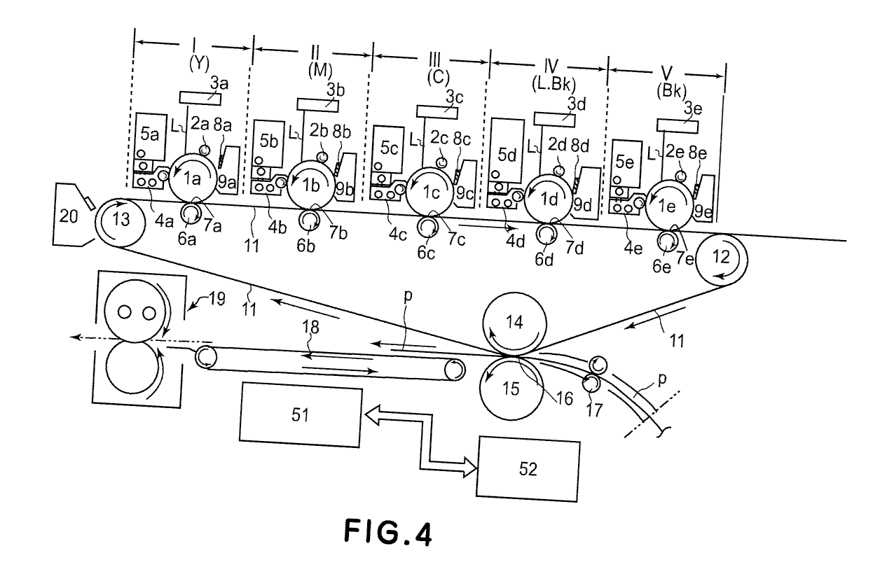

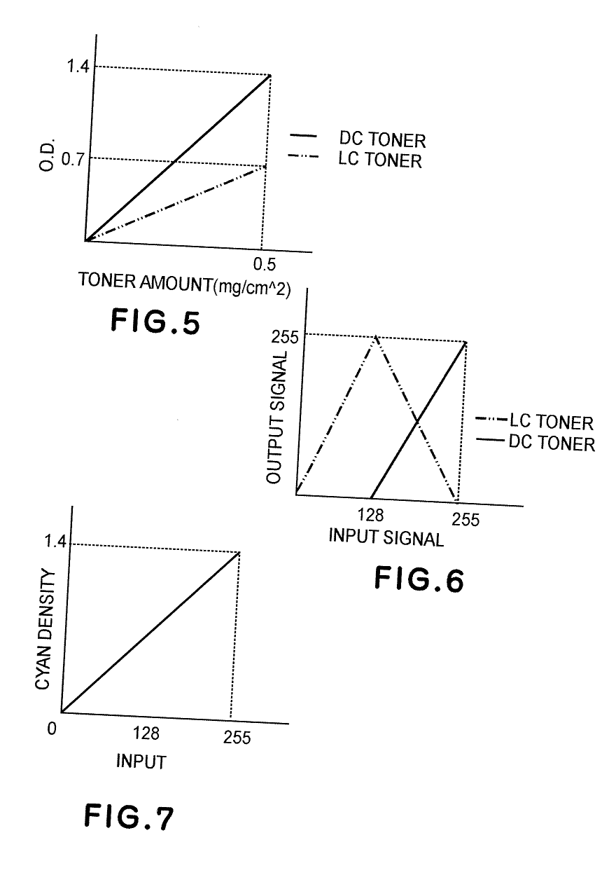

FIG. 4 shows the image forming apparatus in the second preferred embodiment of the present invention.

This image forming apparatus has five image forming portions, that is, the first to fifth image forming portions I-V. It is an electrophotographic full-color copying machine which employs an intermediary transfer belt, and five photosensitive drums juxtaposed in parallel and in series. The first-fifth image forming portions I-V form on the peripheral surfaces of their drums 1, a total of five color images different in color or density, that is, yellow (Y), magenta (M), cyan (C), light black (LBk), and black (Bk) toner images, which correspond to the optical monochromatic images of the primary colors, into which the optical image of a multicolor original is separated. Otherwise, the image forming apparatus in this embodiment is roughly the same in structure, image formation process, etc., as those in the first embodiment. Therefore, the features of the image forming apparatus in this embodiment, which are similar to those of the image forming apparatus in the first embodiment, will not be described.

The first, second, third, and fifth image forming portions I, II, III, and V are the image forming portions which form dark yellow toner image, dark magenta toner image, dark cyan toner image, and dark black toner image, respectively, and the fourth image forming portion IV is the image forming portion which forms a light black color toner image.

This image forming apparatus is designed so that the toner bottle 5d, that is, the toner bottle for the fourth image forming portion IV, that is, the image forming portion for forming a light black toner image, and the waste toner container 9d, that is, the waste toner container for light black waste toner, are greater in capacity than their counterparts in the fifth image forming portion V.

As described above, a substantial area of a photographic image is of halftone or higher in tone. Therefore, when forming a pictographic image which matches a silver-salt photograph in quality, the amount of light black toner (light color toner) consumption is greater than the amount of dark black toner (dark color toner) consumption. Thus, if the waste toner containers 9d and 9e of the fourth and fifth image forming portions IV and V, respectively, are the same in capacity, the waste toner container 9d, that is, the waste toner container for the light black toner, is filled up earlier than the waste toner container 9e, that is, the waste toner container for the dark black toner. That is, the waste toner container 9d, that is, the waste toner container for the light black toner, is shorter in service life than the waste toner container 9e, that is, the waste toner container for the dark black toner. This is problematic in that the waste toner container 9d, that is, the waste toner container for light black toner, has to be more frequently replaced than the other waste toner containers, that is, the waster containers for dark color toners.

In this embodiment, therefore, the waste toner container 9d, that is, the waste toner container for light black (light color) waste toner, is rendered greater in capacity than the waste toner container 9e, that is, the waste toner container for dark black (dark color) waste toner, to extend the service life of the light black waste toner container 9d.

The size of the waste toner container for the light black (light color) toner and the size of the toner bottle for the dark black (dark color) toner, are decided according to the LUT (tone curve) given in FIG. 6, which shows the relationship between the amount (picture signal value) of dark color toner consumption and the amount (picture signal value) of light color toner consumption, during the formation of a pictographic image which match a silver-salt photograph in quality, as they were decided in the first embodiment.

More specifically, in this embodiment, the toner capacity for the toner bottled 5d, that is, the toner bottle for light color toner, was set to roughly 190 cm³. The toner capacity for the toner bottle 5e, that is, the toner bottle for dark toner, was set to roughly 90 cm³.

The size of the internal space of the light color waste toner container 9d which the waste toner is allowed to occupy was set to 25 cm³. As for the size for the waste toner containers 9a, 9b 9c, and 9e, that is, the waste toner containers for dark color toner, the amount of space which the waste toner is allowed to occupy in each of the waste toner containers 9a, 9b, 9c, and 9e was set to 15 cm³, based on the relationship between the amount of light toner consumption and the amount of dark toner consumption by the image forming apparatus in the first embodiment.

Each of the first-fifth image forming portions I-V in the image forming apparatus in this embodiment is in the form of a process cartridge, which is removably mountable in the main assembly of the image forming apparatus. Each process cartridge is made up of the drum 1, charge roller 2, developing apparatus 4, cleaning apparatus 8, waste toner container 9, and a cartridge in which the preceding components are integrally disposed. Each process cartridge may be designed as an ALL-IN-ONE process cartridge, that is, a process cartridge which includes a toner bottle 5 in addition to the above listed components. Incidentally, the process cartridge in this embodiment is desired to have a minimum of the drum 1, cleaning apparatus 8, and waste toner container 9.

In the above, two of the preferred embodiments of the present invention were concretely described. However, the two embodiments are not intended to limit the present invention in scope. In other words, the present invention includes various modifications of the preceding preferred embodiments as long as the modifications fall within the technical field encompassed by the gist of the present invention.

The numerical values mentioned in the above description of the preferred embodiments are nothing but examples; numerical values other than those mentioned may be used as necessary.

The image forming apparatus in each of the preceding embodiments of the present invention was a full-color image copying machine. However, the preceding embodiments are not intended to limit the present invention in scope. That is, the present invention is also applicable to image forming apparatuses other than those in the preceding embodiments. For example, the present invention is also applicable to a printer, a facsimile machine, etc., which are provided with two or more image forming portions (process cartridges).

The present invention is also applicable to an image forming apparatus which does not employ an intermediary transfer medium. That is, it is also applicable to an image forming apparatus in which toner images formed on the image bearing members of the image forming portions, one for one, are transferred in layers directly onto the surface of recording medium, by moving the recording medium through the transfer nip of each of the two or more image forming portions one after another with the use of the conveyer belt or conveyer drum.

The toner image forming process of each of the image forming portions, which is compatible with the present invention, is not limited to an electrophotographic image forming process. That is, the present invention is also compatible with an electrostatic recording process or a magnetic recording process, which employs a dielectric member or a magnetic member, respectively, as the first image bearing member. Further, even in the case of an image forming apparatus which uses an electrophotographic process, the exposing apparatus as the latent image forming means, may be an exposing apparatus made up of a light emitting diode (LED) array, a digital exposing apparatus made up of a combination of a light source and a liquid crystal shutter, or the like. It may be an optical projecting apparatus (analog exposing apparatus) equipped with a set of color separation filters. Further, it may be an exposing apparatus structured to write an electrostatic latent image which reflects picture information, on the charged surface of a first image bearing member, by removing electric charge from the selected points of the charge surface of the first image bearing member, with the use of a charge removing means, such as a charge removing head in the form of a needle, an electron gun, or the like. An exposing apparatus may be located inside or outside of a process cartridge.

As described above, the present invention makes it possible to provide an image forming apparatus which is significantly smaller, and yet, is significantly longer in the service life of the waste toner container of its light color toner image forming portion(s), that is, the image forming portion(s) greater in toner consumption (frequency of usage).

Further, the present invention makes it possible to provide an image forming apparatus which is significantly lower than an image forming apparatus in accordance with the prior art, in the frequency with which a toner supply container for supplying toner to the developing apparatus of the abovementioned image forming portion(s) higher in the amount of toner consumption, needs to be replaced.

Further, the present invention makes it possible to provide an image forming apparatus which is significantly smaller, significantly longer in the service life of the waste toner container for an image forming portion(s) higher in toner consumption, and significantly low in the frequency with which a toner supply container for supplying toner to the developing apparatus of the abovementioned image forming portion(s) higher in the amount of toner consumption, needs to be replaced.

While the invention has been described with reference to the structures disclosed herein, it is not confined to the details set forth, and this application is intended to cover such modifications or changes as may come within the purposes of the improvements or the scope of the following claims.

This application claims priority from Japanese Patent Application No. 243937/2006 filed Sep. 8, 2006, which is hereby incorporated by reference.

1. An image forming apparatus comprising;
a first image forming station for forming, on the basis of an input signal indicative of an image, a toner image on a recording material with such a toner of toners having the same hue and different lightness as has a predetermined color and a low lightness;
a second image forming station for forming, on the basis of an input signal indicative of an image, a toner image on the recording material with such a toner of the toners having the same hue and different lightness as has the predetermined color and a high lightness;
changing means for changing a toner amount per unit area in each of said first image forming station and said second image forming station in accordance with a density level indicated by the image input signal for the predetermined color so that in a low density range, the toner amount per unit area is larger in the second image forming station than in the first image forming station;
a first residual toner container for accommodating toner removed by first cleaning means for removing toner remaining on a surface of said first image bearing member; and
a second residual toner container for accommodating toner removed by second cleaning means for removing toner remaining on a surface of said second image bearing member.

2. An apparatus according to claim 1, wherein the toners having the same hue and different lightnesses comprise coloring materials exhibiting substantially the same spectral characteristics and have different coloring material contents.

3. An apparatus according to claim 1, wherein the toner having the same hue and low density exhibits an optical density less than 1.0 per 0.5 mg/cm² of the amount of the toner on the recording material, and the toner having the same hue and high density exhibits an optical density not less than 1.0 per 0.5 mg/cm² of the amount of the toner on the recording material.

4. An image forming apparatus comprising:
a first image forming station including a first image bearing member, first developing means for developing an electrostatic latent image formed, in accordance with an input signal indicative of an image, on a surface of said first image bearing member, with such a toner of toners having the same hue and different lightness as has a predetermined color and a low lightness, and a first toner supply container for supplying toner to said first developing means, said first image forming station being effective to form the toner image on a recording material;
a second image forming station including a second image bearing member, second developing means for developing an electrostatic latent image formed, in accordance with an input signal indicative of an image, on a surface of said second image bearing member, with such a toner of the toners having the same hue and different lightness as has the predetermined color and a high lightness, and a second toner supply container for supplying toner to said second developing means, said second image forming station being effective to form the toner image on the recording material; and
changing means for changing a toner amount per unit area in each of said first image forming station and said second image forming station in accordance with a density level indicated by the image input signal for the predetermined color so that in a low density range, the toner amount per unit area is larger in the second image forming station than in the first image forming station.

5. An apparatus according to claim 4, wherein the toners having the same hue and different lightnesses comprise coloring materials exhibiting substantially the same spectral characteristics and have different coloring material contents.

6. An apparatus according to claim 4, wherein the toner having the same hue and low density exhibits an optical density less than 1.0 per 0.5 mg/cm² of the amount of the toner on the recording material, and the toner having the same hue and high density exhibits an optical density not less than 1.0 per 0.5 mg/cm² of the amount of the toner on the recording material.
